(19) United States
(12) Patent Application Publication
(10) Pub. No.: US 2010/0236008 A1
(43) Pub. Date: Sep. 23, 2010

(54) Windshield wiper

(76) Inventors: Chih-Ming Yang, Banqiao City (TW); Chuan-Chih Chang, Banqiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,446

(22) Filed: Mar. 17, 2009

(51) Int. Cl. B60S 1/40

(52) U.S. Cl. 15/250.32

(57) ABSTRACT

A windshield wiper includes a flexible support with fasteners and positioning holes, a connecting piece fixedly connected to the flexible support, a warping piece that has a positioning portion which extends to form an elastic portion with locking pieces, a positioning piece, and a windshield wiper blade with the fasteners fastened to its two ends. The middle portion and the end portion of the flexible support have different curvatures. The positioning portion has a through-hole and abuts the flexible support. The positioning piece passes through the through-hole and the positioning hole to be fastened to the flexible support. The locking piece is fastened to the windshield wiper blade. Therefore, the windshield wiper blade is prevented from shaking due to an external force, by being attached to the windshield tightly through the warping piece and the positioning piece. Thus, its effect of wiping away rain is increased.

### BACKGROUND OF THE INVENTION

1. Field of the Invention

The present invention relates to a windshield wiper, and in particular, to a windshield wiper used in a car.

2. Description of Related Art

Windshield wiper is mounted in front of the windshield of a car. With a driving arm exerting a force on the windshield wiper, the windshield wiper is attached to the windshield. The driving arm drives the windshield wiper to swing on the windshield repeatedly so as to wipe off rains thereon. Please refer to FIG. 1. Conventional windshield wiper includes a windshield wiper support 1a and a windshield wiper blade 2a. The windshield wiper blade 2a is fastened to the windshield wiper support 1a. The windshield wiper support 11a comprises a primary support 11a, two secondary supports 12a and two fastening supports 13a. The middle of the primary support 11a has a pivot 111a for pivoting to the driving arm (not shown). Both ends of the primary support 11a have a first pivoting portion 112a respectively for pivoting to the secondary support 12a. The outside end of each secondary support 12a is provided with a first fastening piece 121a for fastening the end of the windshield wiper blade 2a respectively. The inside end of the secondary support 12a has a second pivoting portion 122a for pivoting to the fastening support 13a. Both ends of the fastening support 13a are provided with a second fastening piece 131a respectively for fastening the windshield wiper blade 2a.

However, the conventional windshield wiper has drawbacks as follows:

(I) The windshield wiper blade 2a is fastened to the secondary support 12a and the fastening support 13a via the first fastening piece 121a and the second fastening piece 131a. The flexible deformation of the secondary support 12a and the fastening support 13a is small. When the driving arm (not shown) drives the windshield wiper blade 2a to swing on the windshield repeatedly, a portion of the windshield wiper blade 2a cannot be attached to the windshield completely, which may reduce its effect of wiping rains.

(II) The primary support 11a, the secondary support 12a and the fastening support 13a are pivoted to one another via the first pivoting portion 112a and the second pivoting portion 122a. Thus, these elements may get loosened due to the clearance fit among rigid bodies. When the windshield wiper swings on the windshield repeatedly, noise may be generated easily. Also, the windshield wiper blade 2a may shake easily to reduce its effect of wiping rains.

Consequently, because of the above limitation resulting from the technical design of prior art, the inventor strives via real world experience and academic research to develop the present invention, which can effectively improve the limitations described above.

### SUMMARY OF THE INVENTION

The objective of the present invention is to provide a windshield wiper. With a warping piece and a positioning piece, the windshield wiper blade can be attached tightly to the windshield without shaking due to an external force. Thus, its effect of wiping rains can be increased and the generation of noise is prevented

To achieve the above-mentioned objective, the present invention provides a windshield wiper, which includes: a flexible support with its middle portion and end portion having different curvatures, one surface of the flexible support being provided with at least two fasteners and at least one positioning holes; a connecting piece fixedly connected to one surface of the flexible support; at least one warping piece having a positioning portion and at least one elastic portion, one end of the positioning portion extending to form the elastic portion, the positioning portion abutting the flexible support, the positioning portion being provided with a through-hole, the elastic portion having at least one locking piece; at least one positioning piece passing through the through-hole and the positioning hole to be fastened to the flexible support; and a windshield wiper blade, the two fasteners being fastened to both ends of the windshield wiper blade, the locking piece being fastened to the windshield wiper blade.

The present invention has advantageous features as follows.

(I) Since the middle portion and the end portion of the flexible support have different curvatures, the windshield wiper can be attached more tightly to the windshield, thereby increasing its effect of wiping rains.

(II) Depending on the variation in contact force between the windshield wiper and the windshield, the warping piece generates a corresponding deformation. Thus, when the degree of curvature of the windshield varies, the degree of curvature of the windshield wiper blade varies accordingly. The windshield wiper blade can be attached more tightly to the windshield, thereby increasing its effect of wiping rains.

(III) In addition to correspond to the curvature of the flexible support, the curvature of the windshield wiper blade also corresponds to the deformation of the warping piece. Thus, the warping piece is partially disposed in the flexible support, so that the problem that a portion of the windshield wiper blade is not attached to the windshield is prevented. As a result, its effect of wiping rains can be increased.

(IV) The positioning piece allows the warping piece to be assembled to the flexible support rapidly and easily, so that the time for assembling the windshield wiper is reduced and the detachment process is facilitated. Furthermore, the positioning piece allows the warping piece to be fixed tightly to the flexible support and provides a firm connection for the positioning portion. Thus, the warping piece is prevented from shaking, and the generation of noise is reduced. Also, the windshield wiper blade is prevented from shaking.

In order to further understand the techniques, means and effects of the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a schematic view of a conventional windshield wiper;

FIG. 2 is a front view of a windshield wiper according to the present invention;

FIG. 2A is a front view of a warping piece and a positioning piece according to the present invention;

FIG. 3 is a partial top view of the windshield wiper according to the present invention;

FIG. 4A is a perspective view of the positioning piece according to the present invention;

FIG. 4B is a perspective view of the positioning piece according to another embodiment of the present invention;

FIG. 4C is a perspective view of the positioning piece according to a further embodiment of the present invention; and

FIG. 5 is a cross-sectional view showing the line L-L in FIG. 2;

FIG. 6A is a front view of the warping piece according to another embodiment of the present invention; and

FIG. 6B is a front view of the warping piece according to a further embodiment of the present invention.

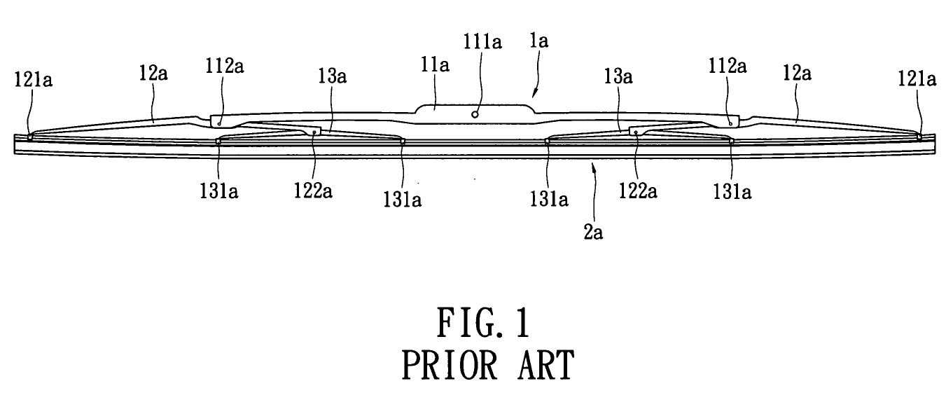

### DETAILED DESCRIPTION OF THE PREFERRED EMBODIMENTS

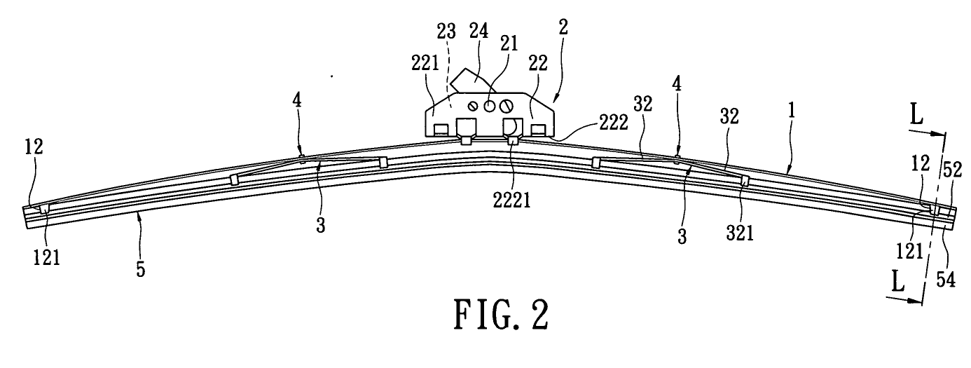

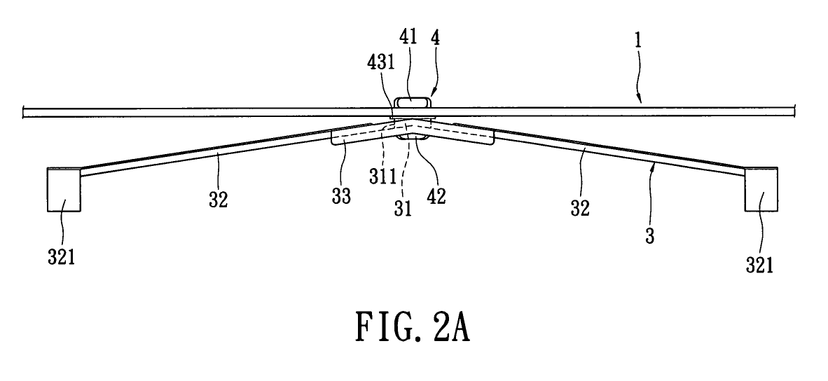

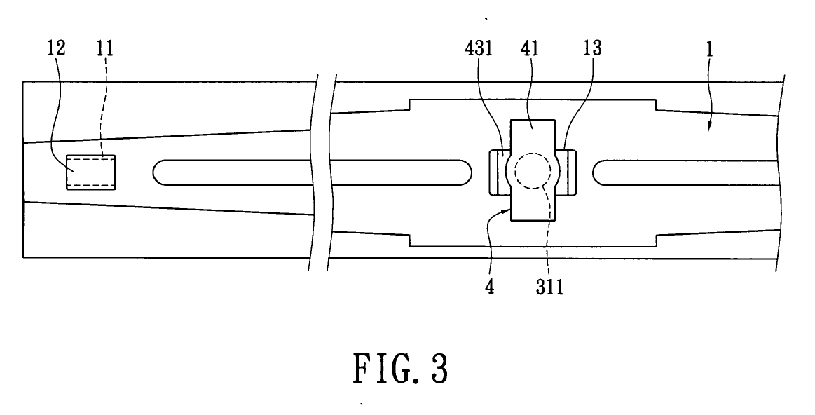

Referring now to FIGS. 2, 2A, and 3. The present invention is to provide a windshield wiper. With a driving arm 24 exerting an action force on the windshield wiper, the windshield wiper can be attached to the windshield of a car. The driving arm 24 drives the windshield wiper to swing repeatedly on the windshield. The windshield wiper includes a flexible support 1, a connecting piece 2, two warping pieces 3, two positioning pieces 4, and a windshield wiper blade 5.

The flexible support 1 is shaped as an elongate strip and has a Yang Module of 50˜350 GPa. The middle portion and end portion of the flexible support 1 have different curvatures. The top surface of the flexible support 1 is provided with two pairs of fastening holes 11, two fasteners 12 and two positioning holes 13 (FIGS. 2 and 3). The two pairs of fastening holes 11 are provided on both end of the top surface of the flexible support 1 and penetrate to the bottom surface of the flexible support 1. The fastener 12 has two first locking pieces 121 that are symmetrical to each other and separated from each other. The two first fastening pieces 121 are inserted into the two pairs of fastening holes 11 and are fastened to the windshield wiper blade 5. The positioning holes 13 are provided in the center of the middle portion and the end portion, which are located on the top surface of the flexible support 1 and penetrate to the bottom surface of the flexible support 1. When the windshield wiper is subjected to an external force, the flexible support 1 bears the action force to generate a flexible deformation, so that the external force is uniformly distributed on the flexible support 1 so as to make the windshield wiper be attached tightly to the windshield. However, since the middle portion and the end portion of the flexible support 1 have different curvatures, the windshield wiper can be attached more tightly on the windshield, thereby increasing its effect of wiping rains. Furthermore, the curvature, length, width, and thickness of the flexible support 1 are dependent on the contact force of the windshield wiper, and thus they can be modified according to practice demands. In the present embodiment, the curvature of the middle portion of the flexible support 1 is smaller than that of the end portion, wherein the flexible support 1 is 500 mm in length, 14 mm in width, 0.8 mm in thickness, but these dimensions are not limited thereto.

The connecting piece 2 is disposed on the top surface of the flexible support 1. The connecting piece 2 has a pivoting portion 21 and a fixing portion 22. The fixing portion 22 has two symmetrical side plates 221 and a bottom plate 222. The side plates 221 are separated from each other and arranged in parallel on the bottom plate 222. The side plates 221 and the bottom plate 222 are arranged vertically to be integrated into one unit. The side plates 221 and the bottom plate 222 enclose to form an accommodating chamber 23. Both side edges of the bottom plate 222 have two fixing pieces 2221 respectively. The fixing piece 2221 is fixedly connected to the flexible support 1 for fixing the connecting piece 2 to the flexible support 1. Both ends of the pivoting portion 21 are fixedly connected to the two side plates 221. The pivoting portion 21 is pivoted to the driving arm 2 that is disposed in the accommodating chamber 23. The driving arm 24 can exert an action force on the connecting piece 2, so that the windshield wiper can be attached to the windshield. The driving arm 24 drives the windshield wiper to swing repeatedly on the windshield, thereby wiping off rains on the windshield.

Each of the warping pieces 3 has a positioning portion 31, two elastic portions 32, and two reinforcing ribs 33. The positioning portion 31 abuts the bottom surface of the flexible support 1. Both ends of the positioning portion 31 extend downwards to form the elastic portion 32. The positioning portion 31 and the elastic portion 32 are shaped as a seesaw respectively (FIG. 2A), so that the elastic portion 32 swings up-and-down by means of using the positioning portion 31 as a fulcrum. The reinforcing ribs 33 are provided on both side edges of the positioning portion 31 and the elastic portion 32, thereby increasing the strength of the warping piece 3. The positioning portion 32 and the elastic portion 32 are integrally formed into one unit. The positioning portion 31 is provided with a through-hole 311. Each of the elastic portions 32 has two second locking pieces 321 that are symmetrical to each other and separated from each other. The second locking pieces 321 are fastened to the windshield wiper blade 5. When the windshield wiper swings on the windshield, the positions on which the windshield wiper is attached to the windshield changes with time, so that the windshield wiper blade 5 can contact the portions of windshield having different degrees of curvature. As a result, the contact force between the windshield wiper blade 5 and the windshield also changes with time. Further, according to various contact forces, the warping piece 3 whose elastic portion 32 swings up-and-down by means of using the positioning portion 31 as a fulcrum generates a corresponding deformation, so that the degree of curvature of the windshield wiper blade 5 fastened to the second locking pieces 321 can be changed with the degree of curvature of the windshield. Thus, the windshield wiper blade 5 can be attached more tightly to the windshield. Furthermore, the warping piece 3 is deformed by an external action force, which in turn changes the degree of curvature of the windshield wiper blade 5. As a result, in addition to correspond to the curvature of the flexible support 1, the curvature of the windshield wiper blade 5 also corresponds to the deformation of the warping piece 3. Thus, the warping piece 3 is partially provided on the flexible support 1, thereby avoiding the problem that portions of the windshield wiper blade 5 cannot be attached to the windshield and increasing its effect of wiping rains. Furthermore, the positions on which the warping piece 3 may be provided on the flexible support 1 and the number of the warping pieces 3 can be varied according to practical demands. In the present embodiment, two warping pieces 3 are provided, and the positions of the warping pieces 3 correspond to those of the positioning holes 13 respectively.

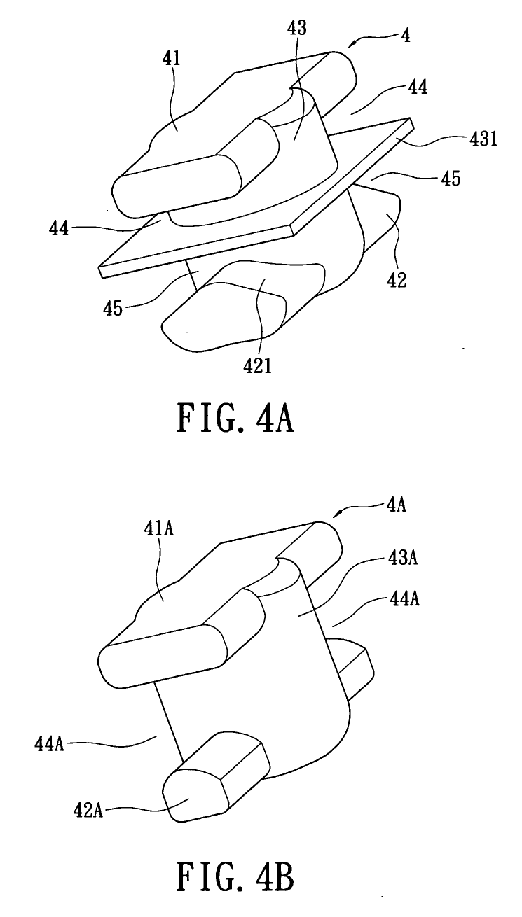

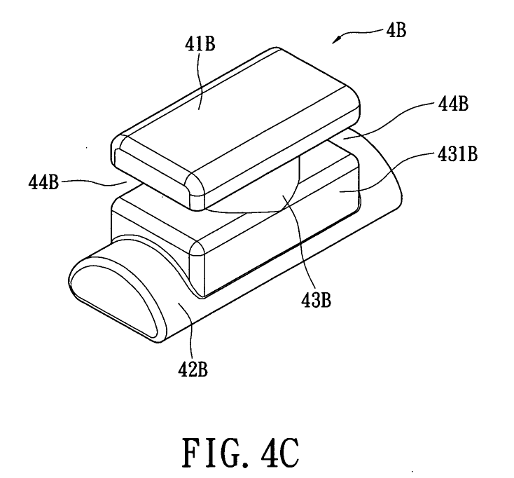

Each of the positioning pieces 4 has a top portion 41, a base portion 42, and a beam portion 43 (FIG. 4A). The top portion 41 is shaped as an elongate strip. The base portion 42 is slightly shaped as an elongate strip. The middle of the base portion 42 is provided with a flange 421. One end of the beam portion 43 is fixedly connected to the top portion 41. The other end of the beam portion 43 is fixedly connected to the base portion 42, so that the top portion 41 and the base portion 42 are separated from each other and arranged in parallel on both ends of the beam portion 43. The middle of the beam portion 43 is provided with a partition 431. The partition 431 is disposed between the top portion 41 and the base portion 42 to be parallel with them. The top portion 41, the base portion 42, and the beam portion 43 are integrally formed into one unit. The top portion 41, the base portion 42, and the beam portion 43 enclose to form a pair of first positioning grooves 44 and a pair of second positioning grooves 45. The height of the first positioning grooves 44 corresponds to the thickness of the corresponding flexible support 1. The height of the second positioning groove 45 corresponds to the thickness of the positioning portion 31. The top portion 41 passes through the through-hole 311 of the positioning portion 31 and the positioning hole 13 of the flexible support 1 (FIG. 3), and it is rotatably fastened to the top surface of the flexible support 1. The bottom surface of the top portion 41 and the top surface of the partition 431 abut the flexible support 1 (FIG. 2A). The flange 421 of the base portion 42 and the bottom surface of the partition 431 abut the warping piece 3, so that the flexible support 1 and the warping piece 3 are fastened to the first positioning groove 44 and the second positioning groove 45 respectively. The warping piece 3 is fixed to the flexible support 1. The positioning piece 4 allows the warping piece 3 to be assembled to the flexible support 1 rapidly and easily, thereby reducing the time for assembling the windshield wiper and facilitating the detachment thereof. The flexible support 1 and the warping piece 3 are fastened to the first positioning groove 44 and the second positioning groove 45 respectively, so that the warping piece 3 can be connected tightly to the flexible support 1 to provide the positioning portion 31 with a firm connection. Thus, the warping piece 3 is prevented from shaking due to an external force and in turn the generation of noise can be prevented. Also, the windshield wiper blade 5 is prevented from shaking.

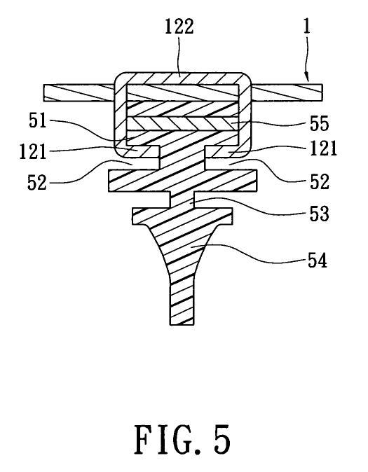

Both ends of the windshield wiper blade 5 are fastened to the fasteners 12 of the flexible support 1, so that the curvature of the windshield wiper blade 5 substantially coincides with that of the flexible support 1. The windshield wiper blade 5 comprises an assembling portion 51, two engaging grooves 52, a connecting portion 53, a wiping piece 54, and a reinforcing piece 55 (FIG. 5). Both side faces of the assembling portion 51 are provided with an engaging groove 52 respectively. The engaging groove 52 corresponds to the first locking piece 121 and the second locking piece 321 (FIG. 2), so that the first locking piece 121 and the second locking piece 321 are fastened in the engaging groove 52. The assembling portion 51 is shaped as an elongate strip of the same width. The bottom surface of the assembling portion 51 is connected to the top surface of the connecting portion 53. The bottom surface of the connecting portion 53 is connected to the top surface of the wiping piece 54. The assembling portion 51, the connecting portion 53, and the wiping piece 54 are integrally formed into one unit. The connecting portion 53 is shaped as an elongate strip of the same width. The width of the connecting portion 53 is smaller than that of the assembling portion 51. The wiping piece 54 is shaped as an elongate strip. The width of the top surface of the wiping piece 54 is larger than that of the connecting portion 53. The width of the wiping piece 54 tapers from its top surface to its bottom surface. Thus, when the bottom surface of the wiping piece 54 is subjected to a lateral force, the wiping piece 54 can swing laterally by means of using the connecting portion 53 as a fulcrum. The interior of the assembling portion 51 is coated with the reinforcing piece 55 for increasing the strength of the windshield wiper blade 5, so that the windshield wiper blade 5 and the flexible support 1 are assembled to form one unit. In general, the windshield wiper blade S is made of soft rubber with high toughness. However, in the present invention, any suitable soft material with high toughness may be employed.

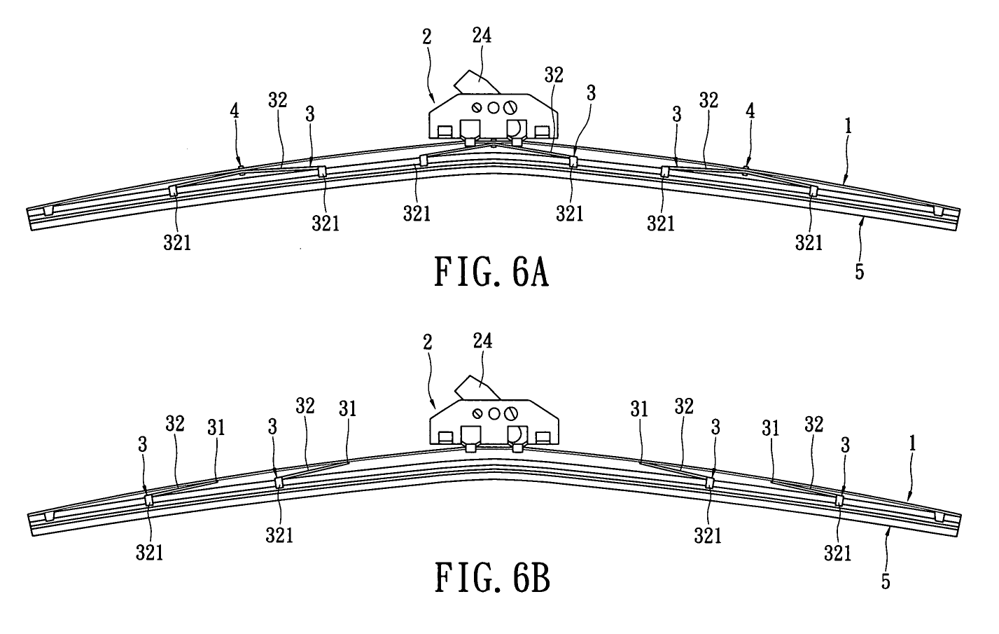

The warping piece 3 can be designed into various forms. The number of the warping pieces 3 can be increased up to three or more (FIGS. 6A and 6B), so that the warping pieces 3 can be distributed uniformly on the flexible support 1. Alternatively, the warping piece 3 can have a positioning portion 31 and an elastic portion 32 (FIG. 6B). The positioning portion 31 is fixed directly to the bottom surface of the flexible support 1 by means of welding, screw elements or rivets.

Furthermore, the positioning piece 4A can be designed into various forms. Please refer to FIG. 4B. Each of the positioning pieces 4A has a top portion 41A, a base portion 42A, and a beam portion 43A. The top portion 41A is shaped as an elongate strip. The base portion 42A is shaped as a semi-circular post. One end of the beam portion 43A is fixed to the top portion 41A. The other end of the beam portion 43A is fixed to the base portion 42A, so that the top portion 41A, and the base portion 42A are separated from each other and disposed in parallel on both ends of the beam portion 43A. The top portion 41A, the base portion 42A, and the beam portion 43A are integrally formed into one unit. The bottom surface of the top portion 41A, the top surface of the base portion 42A, and the outer wall of the beam portion 43A enclose to form a pair of positioning grooves 44A. The height of the positioning groove 44A corresponds to the thicknesses of the flexible support 1 and the positioning portion 31. The top portion 41A passes through the through-hole 311 of the positioning portion 31 and the positioning hole 13 of the flexible support 1, and it is rotatably fastened to the top surface of the flexible support 1. The bottom surface of the top portion 41A abuts the top surface of the flexible support 1. The top surface of the base portion 42A abuts the bottom surface of the positioning portion 31 of the warping piece 3, so that the flexible support 1 and the warping piece 3 can be fastened to the positioning groove 44A. The warping piece 3 is fixed to the flexible support 1.

Furthermore, please refer to FIG. 4C. Each of the positioning pieces 4B has a top portion 41B, a base portion 42B, and a beam portion 43B. The top portion 41B is shaped as an elongate strip. The base portion 42B is shaped as a semi-circular post. One end of the beam portion 43B is fixed to the top portion 41B. The other end of the beam portion 43B is fixed to the base portion 42B, so that the top portion 41B and the base portion 42B are separated from each other and disposed in parallel on both ends of the beam portion 43B. The beam portion 43B has a restricting portion 431B. The bottom surface of the top portion 41B, the top surface of the restricting portion 431B, and the outer wall of the beam portion 43B enclose to form a pair of positioning grooves 44B. The height of the positioning groove 44B corresponds to the thicknesses of the flexible support 1 and the positioning portion 31. When the flexible support 1 and the warping piece 3 are fastened to the positioning groove 44B, the restricting portion 43 1B abuts the warping piece 3, so that the warping piece 3 can be fixed to the flexible support 1 more firmly. Via this arrangement, when the elastic portion 32 swings up-and-down by using the positioning portion 31 as a fulcrum, its stability can be increased.

The present invention has advantageous features as follows.

(I) Since the middle portion and the end portion of the flexible support 1 have different curvatures, the windshield wiper can be attached more tightly to the windshield, thereby increasing its effect of wiping rains.

(II) Depending on the variation in contact force between the windshield wiper and the windshield, the warping piece 3 generates a corresponding deformation. Thus, when the degree of curvature of the windshield varies, the degree of curvature of the windshield wiper blade 5 varies accordingly. The windshield wiper blade 5 can be attached more tightly to the windshield, thereby increasing its effect of wiping rains.

(III) In addition to correspond to the curvature of the flexible support 1, the curvature of the windshield wiper blade 5 also corresponds to the deformation of the warping piece 3. Thus, the warping piece 3 is partially disposed in the flexible support, so that the problem that a portion of the windshield wiper blade 5 is not attached to the windshield can be prevented. As a result, its effect of wiping rains can be increased.

(IV) The positioning piece 4 allows the warping piece 3 to be assembled to the flexible support 1 rapidly and easily, so that the time for assembling the windshield wiper is reduced and the detachment process is facilitated. Furthermore, the positioning piece 4 allows the warping piece 3 to be fixed tightly to the flexible support 1 and provides a firm connection for the positioning portion 31. Thus, the warping piece 3 can be prevented from shaking, and the generation of noise is reduced. Also, the windshield wiper blade 5 can be prevented from shaking.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A windshield wiper, comprising:
a flexible support with its middle portion and end portion having different curvatures, one surface of the flexible support being provided with at least two fasteners and at least one positioning hole;
a connecting piece fixedly connected to one surface of the flexible support;
at least one warping piece, the warping piece having a positioning portion and at least one elastic portion, an end of the positioning portion extending to form the elastic portion, the positioning portion abutting the flexible support, the positioning portion being provided with a through-hole, the elastic portion having at least one locking piece;
at least one positioning piece passing through the through-hole and the positioning hole to be fastened to the flexible support; and
a windshield wiper blade, the two fasteners being fastened to both ends of the windshield wiper blade, the locking pieces being fastened to the windshield wiper blade.

2. The windshield wiper according to claim 1, wherein the curvature of the middle portion of the flexible support is smaller than that of its end portion.

3. The windshield wiper according to claim 1, wherein the connecting piece has a pivoting portion and a fixing portion, the fixing portion has two symmetrical side plates and a bottom plate, the two side plates are separated from each other and arranged in parallel on the bottom plate, two side edges of the bottom plate have two fixing pieces respectively, the fixing pieces are fixed to the flexible support.

4. The windshield wiper according to claim 1, wherein the warping piece further comprises at least one reinforcing rib, the reinforcing rib is provided on the positioning portion and both side edges of the elastic portion.

5. The windshield wiper according to claim 1, wherein the positioning piece has a top portion, a base portion, and a beam portion, one end of the beam portion is fixed to the top portion, the other end of the beam portion is fixed to the base portion, the top portion and the base portion are separated from each other and arranged in parallel on both ends of the beam portion.

6. The windshield wiper according to claim 5, wherein the base portion is provided with a flange, the beam portion is provided with a partition, the partition is arranged between the top portion and the base portion and is in parallel with them, the top portion and one surface of the partition abut the flexible support, the flange and the other surface of the partition abut the warping piece.

7. The windshield wiper according to claim 6, wherein the top portion, the base portion, and the beam portion enclose a first positioning groove and a second positioning groove, the height of the first positioning groove corresponds to the thickness of the flexible support, the height of the second positioning groove corresponds to the thickness of the positioning portion, the flexible support is fastened to the first positioning groove, the warping piece is fastened to the second positioning groove.

8. The windshield wiper according to claim 5, wherein the top portion is shaped as an elongate piece, the base portion is shaped as a semi-circular post, the top portion abuts the top surface of the flexible support, the base portion abuts the bottom surface of the positioning portion of the warping piece.

9. The windshield wiper according to claim 8, wherein the top portion, the base portion, and the beam portion enclose a positioning groove, the height of the positioning groove corresponds to the thickness of the flexible support and the thickness of the positioning portion, the flexible support and the warping piece are fastened to the positioning groove.

10. The windshield wiper according to claim 5, wherein the top portion is shaped as an elongate strip, the base portion is shaped as a semi-circular post, the beam portion has a restricting portion, the top portion abuts the top surface of the flexible support, the restricting portion abuts the warping piece.

11. The windshield wiper according to claim 10, wherein the top portion, the restricting portion, and the beam portion enclose a positioning groove, the height of the positioning groove corresponds to the thickness of the flexible support and the thickness of the positioning portion, the flexible support and the warping piece are fastened to the positioning groove.

12. The windshield wiper according to claim 1, wherein the windshield wiper blade comprises an assembling portion, two engaging grooves, a connecting portion, a wiping piece, and a reinforcing piece, the two engaging grooves are provided on both side surfaces of the assembling portion, the two fasteners and the locking pieces are fastened to the engaging grooves, the bottom surface of the assembling portion is connected to the top surface of the connecting portion, the bottom surface of the connecting portion is connected to the top surface of the wiping piece, the width of the connecting portion is smaller than the width of the assembling portion, the width of the top surface of the wiping piece is larger than that of the connecting portion, the width of the wiping piece tapers from its top surface to its bottom surface, the assembling portion covers the reinforcing piece.

13. A windshield wiper, comprising:
a flexible support with its middle portion and end portion having different curvatures, one surface of the flexible support being provided with at least two fasteners;
a connecting piece fixedly connected to one surface of the flexible support;
at least one warping piece, the warping piece having a positioning portion and at least one elastic portion, an end of the positioning portion extending to form the elastic portion, the positioning portion abutting the bottom surface of the flexible support, the elastic portion having at least one locking piece; and
a windshield wiper blade, the two fasteners being fastened to both ends of the windshield wiper blade, the locking pieces being fastened to the windshield wiper blade.

14. The windshield wiper according to claim 13, wherein the curvature of the middle portion of the flexible support is smaller than that of its end portion.

15. The windshield wiper according to claim 13, wherein the warping piece further comprises at least one reinforcing rib, the reinforcing rib is arranged to the positioning portion and two side edges of the elastic portion.

16. The windshield wiper according to claim 13, wherein the positioning portion is connected to the flexible support by means of welding, screws or rivets.

17. The windshield wiper according to claim 13, wherein the windshield wiper blade comprises an assembling portion, two engaging grooves, a connecting portion, a wiping piece, and a reinforcing piece, the two engaging grooves are provided on both side surfaces of the assembling portion, the two fasteners and the locking pieces are fastened to the engaging grooves, the bottom surface of the assembling portion is connected to the top surface of the connecting portion, the bottom surface of the connecting portion is connected to the top surface of the wiping piece, the width of the connecting portion is smaller than that of the assembling portion, the width of the top surface of the wiping piece is larger than that of the connecting portion, the width of the wiping piece tapers from its top surface to its bottom surface, the assembling portion covers the reinforcing piece.
